(19) United States
(12) Patent Application Publication
(10) Pub. No.: US 2024/0416818 A1
(43) Pub. Date: Dec. 19, 2024

(54) TELESCOPIC LIFTGATES

(71) Applicant: Tyrone Halbrook, Gresham, OR (US)

(72) Inventor: Tyrone Halbrook, Gresham, OR (US)

(21) Appl. No.: 18/210,275

(22) Filed: Jun. 15, 2023

(51) Int. Cl. B60P 1/44; B60P 1/64

(52) U.S. Cl. CPC B60P 1/4435; B60P 1/4442; B60P 1/4471; B60P 1/64

(57) ABSTRACT

Telescopic liftgates including a first telescopic siderail, a second telescopic siderail, a first pulley, a first elongate tension bearing member, and a platform. The second telescopic siderail extends parallel to the first telescopic siderail. The first and second telescopic siderails include outer and inner members. The inner members are moveably supported by the outer members and configured to extend beyond outer members. The first pulley is mounted to the first inner member. The first elongate tension bearing member is supported on the first pulley. The platform is supported by the first elongate tension bearing member. The platform, the first pulley, and the first elongate tension bearing member cooperate to allow the platform to selectively raise and lower relative to the inner members when the inner members are extended beyond the outer members sufficient that the platform is disposed beyond the rear of the vehicle.

### BACKGROUND

The present disclosure relates generally to liftgates. In particular, telescopic liftgates are described.

Liftgates are useful for lifting and lowering cargo. Liftgates may be used to lift and lower cargo into and out of vehicle or between different levels of loading docks or other buildings.

Known liftgates are not entirely satisfactory. For example, existing liftgates inconveniently extend out beyond a vehicle. A liftgate extending out beyond a vehicle makes the vehicle less maneuverable, such as limiting a vehicle's ability to drive up or down steep inclines. Further, a liftgate extending beyond a vehicle takes up more space, which can make parking the vehicle more difficult.

Some conventional liftgates are configured to stow and deploy to address some of the issues with fixed liftgates. However, conventional liftgates capable of stowing and deploying are typically cumbersome to stow and deploy. Existing deployable liftgates often require pivoting a heavy liftgate. Pivoting a heavy liftgate is difficult for a person to do under human power, so motorized pivoting mechanisms are often required. However, motorized pivoting mechanisms are generally slow, expensive, and loud.

Thus, there exists a need for liftgates that improve upon and advance the design of known liftgates. Examples of new and useful liftgates relevant to the needs existing in the field are discussed below.

### SUMMARY

The present disclosure is directed to telescopic liftgates. The telescopic liftgates include a first telescopic siderail, a second telescopic siderail, a first pulley, a first elongate tension bearing member, and a platform. The second telescopic siderail extends parallel to the first telescopic siderail. The first and second telescopic siderails include outer and inner members. The inner members are moveably supported by the outer members and configured to extend beyond the outer members. The first pulley is mounted to the first inner member. The first elongate tension bearing member is supported on the first pulley. The platform is supported by the first elongate tension bearing member. The platform, the first pulley, and the first elongate tension bearing member cooperate to allow the platform to selectively raise and lower relative to the inner members when the inner members are extended beyond the outer members sufficient that the platform is disposed beyond the rear of the vehicle.

In some examples, the winch includes a first spool coupled to and supporting the first elongate tension bearing member, an axle drivingly coupled to the spool, and a motor drivingly coupled to the axle and configured to selectively rotate the axle clockwise and counterclockwise.

This document describes certain examples where the platform defines a first mounting point and a second mounting point on a first side of the platform. The first elongate tension bearing member is coupled to the first mounting point. In some examples, the liftgate includes a second pulley mounted to the first inner member and spaced from the first pulley. A second elongate tension bearing member may be supported on the second pulley and coupled to the second mounting point. In certain examples, a second spool is mounted to the axle and coupled to the second elongate tension bearing member.

In select embodiments, the platform defines a third mounting point and a fourth mounting point on a second side of the platform opposite the first side of the platform. The liftgate may include a third pulley mounted to the second inner member. A fourth pulley may be mounted to the second inner member and spaced from the third pulley. A third elongate tension bearing member may be supported on the third pulley and coupled to the third mounting point. A fourth elongate tension bearing member may be supported on the fourth pulley and coupled to the fourth mounting point. In some examples, a third spool is mounted to the axle and coupled to the third elongate tension bearing member.

As described below, in particular instances the axle includes a first longitudinal end and a second longitudinal end opposite the first longitudinal end, the first spool is mounted to the axle proximate to the first longitudinal end, the third spool is mounted to the axle proximate to the second longitudinal end.

In some examples, the second spool is mounted to the axle proximate to the first spool.

In some examples, the liftgate includes a fourth spool coupled to the axle and coupled to the fourth elongate tension bearing member.

This document describes certain examples where the fourth spool is mounted to the axle proximate to the third spool. In certain examples, the first pulley, the second pulley, the third pulley, and the fourth pulley are configured to move in tandem to maintain the platform in a horizontal orientation when cooperating to raise and lower the platform.

In select embodiments, the platform is rectangular.

As described below, in particular instances the first mounting point, the second mounting point, the third mounting point, and the fourth mounting point are located at corners of the platform.

In some examples, a strut extends between the first telescopic siderail and the second telescopic siderail. The strut may extend from the first end of the first telescopic siderail to the third end of the second telescopic siderail. In some instances, the liftgate includes a second strut extending between the first telescopic siderail and the second telescopic siderail and spaced from the first strut.

In some examples, the second strut extends from the second end of the first telescopic siderail to the fourth end of the second telescopic siderail. In certain examples, the first elongate tension bearing member is a cable. The platform may be removably supported by the first elongate tension bearing member.

In certain examples, the liftgate includes a second winch. The second winch may include a second spool coupled to and supporting the second elongate tension bearing member, a second axle drivingly coupled to the second spool, and a second motor drivingly coupled to the second axle. The second motor may be configured to selectively rotate the second axle clockwise and counterclockwise. In select examples, the first winch and the second are configured to cooperatively operate to selectively tilt the platform.

### BRIEF DESCRIPTION OF THE DRAWINGS

FIG. 1 is a perspective view of a liftgate mounted to a rear cargo bed of a vehicle with the liftgate in a stowed configuration where the platform is retracted into the cargo bed and raised relative to the ground to be supported above the cargo bed.

FIG. 2 is a perspective view of the liftgate shown in FIG. 1 with the liftgate in an deployed configuration where the platform is extended out past the cargo bed, but still raised relative to the ground.

FIG. 3 is a perspective view of the liftgate shown in FIG. 1 with the liftgate in a loading configuration where the platform is extended out past the cargo bed and lowered towards the ground.

FIG. 4 is a top plan view of the liftgate in the loading configuration.

FIG. 5 is a rear elevation view of the liftgate in the loading configuration.

FIG. 6 is a side elevation view of the liftgate in the loading configuration.

FIG. 7 is a side elevation view of the liftgate with the platform selectively disconnected from the cables.

FIG. 8 is a perspective view of a second example of liftgate where the liftgate is mounted to a cargo rack mounted to a vehicle, the liftgate includes two winches, and a platform of the liftgate is in a level orientation.

FIG. 9 is a perspective view of the liftgate shown in FIG. 8 with the platform in a tilted orientation.

### DETAILED DESCRIPTION

The disclosed liftgates will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various liftgates are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identity various members of a group, or the like, and are not intended to denote a serial, chronological, or numerical limitation.

“Coupled” means connected, either permanently or releasably, whether directly or indirectly through intervening components.

### Telescopic Liftgates

With reference to the figures, telescopic liftgates will now be described. The liftgates discussed herein function to selectively rise and lower cargo. The liftgates may be utilized on vehicles, in buildings, or as freestanding devices at job sites.

The reader will appreciate from the figures and description below that the presently disclosed liftgates address many of the shortcomings of conventional liftgates. For example, the novel liftgates described below do not permanently extend out beyond a vehicle.

As a result of not permanently extending beyond the vehicle, the novel liftgates enable the vehicle to maintain its maneuverability. Thus, a vehicle utilizing the novel liftgate is not subject to liftgate related limitations with going up or down steep inclines. Further, the novel liftgates discussed herein do not increase the effective size of the vehicle, which makes parking the vehicle easier.

The novel liftgates discussed below improve on conventional liftgates configured to selectively stow and deploy. For example, the novel liftgates below are easy and convenient to stow and deploy. Further, the novel liftgates below do not require pivoting a heavy liftgate like conventional depoloyable liftgates often require. As a result, one does not need to use a slow, expensive, and loud pivoting mechanism to use the novel liftgates discussed herein as is often required with conventional depoyable liftgates.

### Contextual Details

Ancillary features relevant to the liftgates described herein will first be described to provide context and to aid the discussion of the liftgates.

### Vehicle.

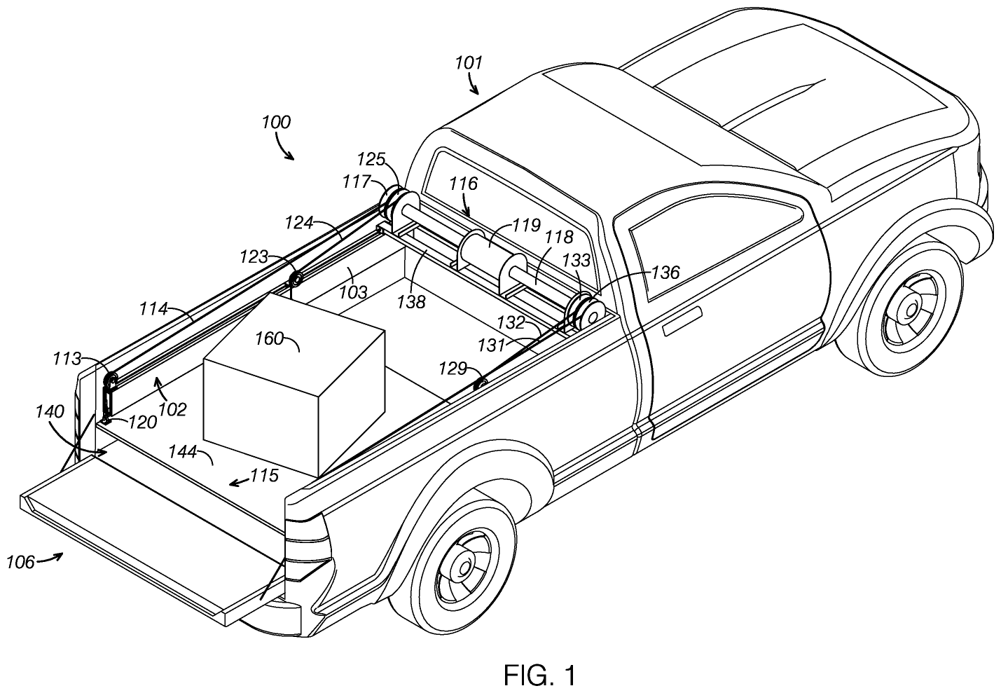

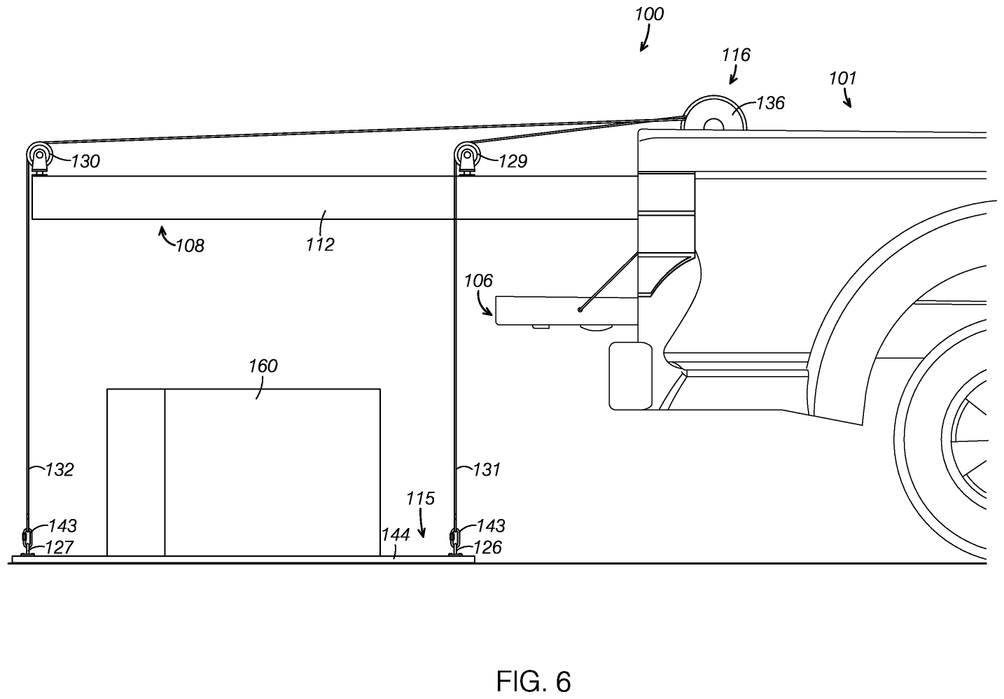

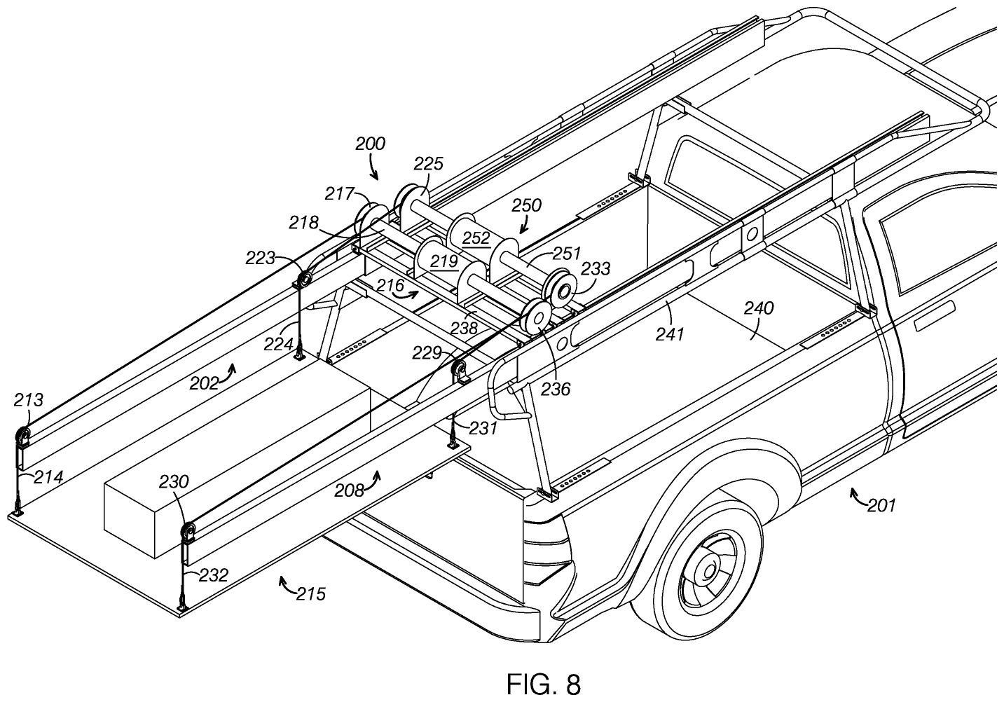

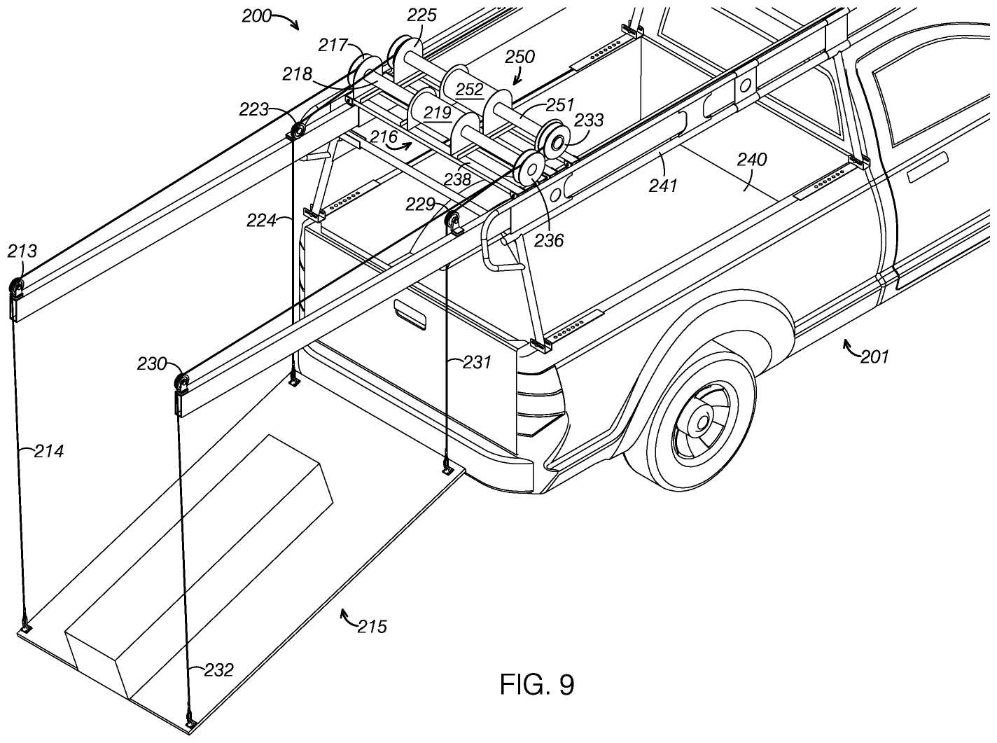

The telescopic liftgates described below are often mounted to vehicles, such as vehicle 101 in the form of a pickup truck depicted in FIGS. 1-7 or vehicle 201 depicted in FIGS. 8 and 9. The reader can see that liftgate 100 is mounted to a cargo bed 140 of truck 101. Vehicle 101 has a rear 106 and liftgate 100 is configured to extend beyond rear 106.

FIGS. 8 and 9 depict a vehicle 201 in the form of a truck with a cargo rack 241 mounted to the vehicle. As shown in FIGS. 8 and 9, liftgate 200 is mounted to cargo rack 241.

The vehicle may be any currently known or later developed type of vehicle. Various vehicle types exist and could be used in place of the vehicle shown in the figures. In addition to the types of vehicles existing currently, it is contemplated that the liftgates described herein could be used with new types of vehicles developed in the future.

The size and shape of the vehicle may be varied as needed for a given application. In some examples, the vehicle is larger relative to the other components than depicted in the figures. In other examples, the vehicle is smaller relative to the other components than depicted in the figures. Further, the vehicle and the other components may all be larger or smaller than described herein while maintaining their relative proportions.

### Car Racks

Vehicles, especially contractor vehicles, are sometimes outfitted with external cargo racks. As shown in FIGS. 8 and 9, the liftgates discussed below may mount to an external cargo rack 241. Cargo rack 241 is mounted to a cargo bed 240 of vehicle 201.

The cargo rack may be any currently known or later developed type of cargo rack. The cargo rack may be larger or smaller than the example depicted in FIGS. 8 and 9. Cargo rack 241 shown in FIGS. 8 and 9 is comprised of metal, but may be comprised of any material suitable for rack applications.

### Liftgate Embodiment One

With reference to FIGS. 1-7, a liftgate 100 will now be described as a first example of a liftgate. The reader can see in FIGS. 1-7 that liftgate 100 is configured to mount to a cargo bed 140 of a vehicle 101.

As shown in FIGS. 1-7, liftgate 100 includes a first telescopic siderail 102, a second telescopic siderail 108, a first pulley 113, a second pulley 123, a third pulley 129, a fourth pulley 130, a first elongate tension bearing member 114, a second elongate tension bearing member 124, a third elongate tension bearing member 131, a fourth elongate tension bearing member 132, a platform 115, a winch 116, and a strut 138.

In other examples, the liftgate includes fewer components than depicted in the figures. In certain examples, the liftgate includes additional or alternative components than depicted in the figures. The components of liftgate 100 are described in the sections below.

The size and shape of the liftgate may be varied as needed for a given application. In some examples, the liftgate is larger relative to the other components than depicted in the figures. In other examples, the liftgate is smaller relative to the other components than depicted in the figures. Further, the liftgate and the other components may all be larger or smaller than described herein while maintaining their relative proportions.

### Telescopic Siderails

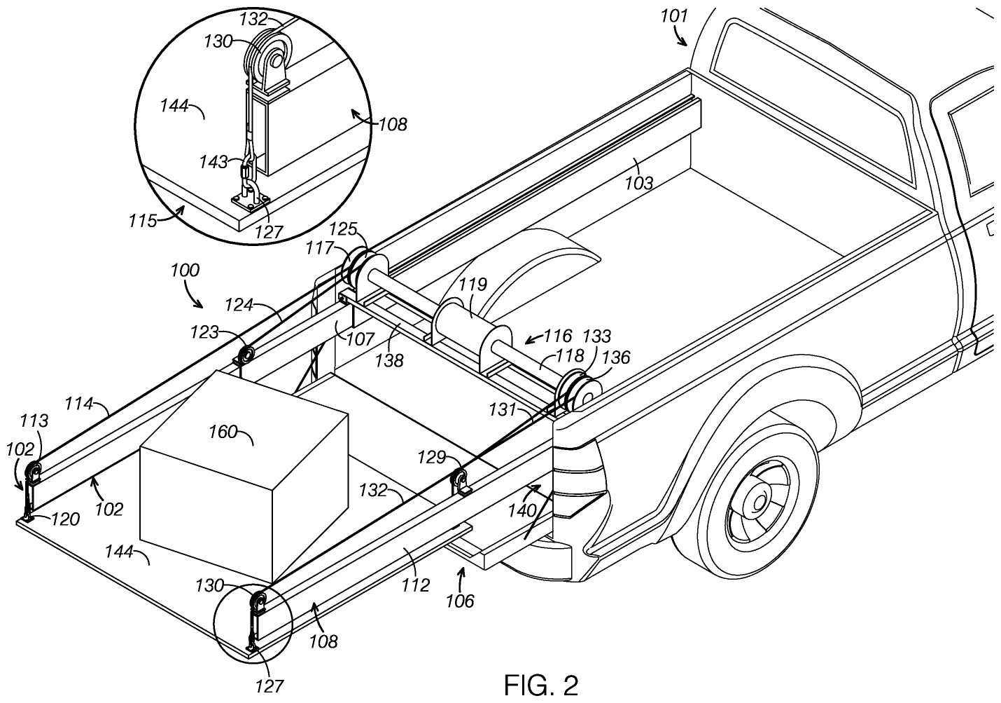

Telescopic siderails 102 and 108 serve to couple telescopic liftgate 100 to cargo bed 140 of vehicle 100. Further, telescopic siderails 102 and 108 support other components of telescopic liftgate 100, such as the pulleys and platform 115. Telescopic siderails 102 and 108 also enable liftgate 100 to selectively deploy between the stowed configuration shown in FIG. 1 and the deployed configuration shown in FIG. 2.

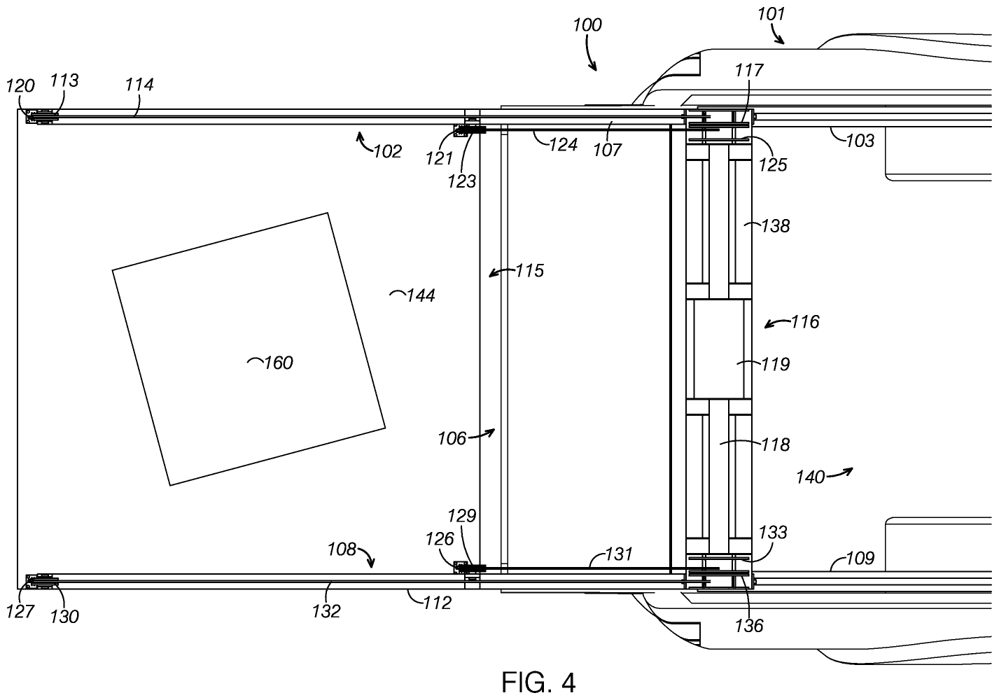

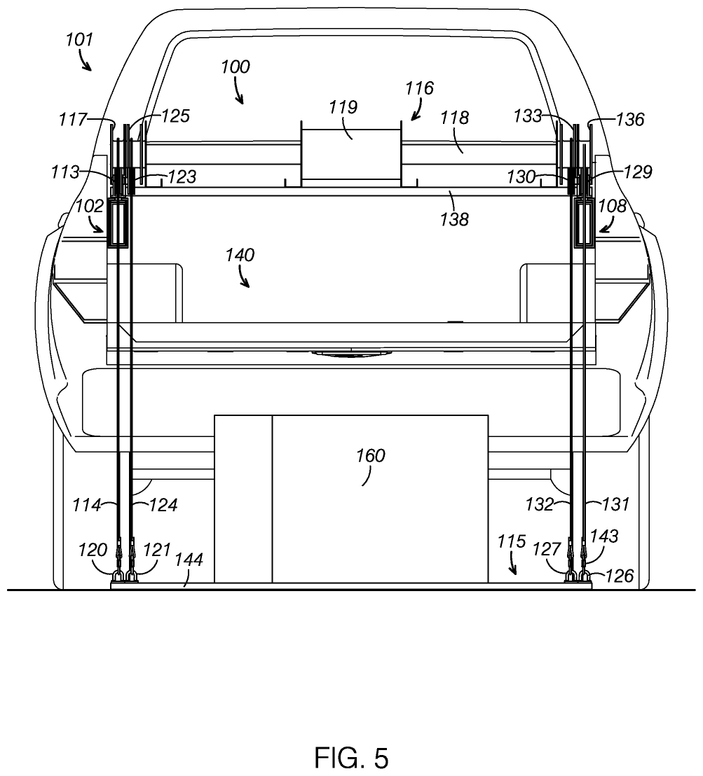

The reader can see in FIGS. 4 and 5 that telescopic siderails 102 and 108 are mounted to opposite lateral sides of cargo bed 140 of vehicle 101. However, other mounting configurations are contemplated, such as mounting the siderails to the floor of the cargo bed. With reference to FIGS. 1-5, second telescopic siderail 108 extends parallel to first telescopic siderail 102.

As depicted in FIGS. 2-4, first telescopic siderail 102 includes a first outer member 103 and a first inner member 107. Similarly, as shown in FIGS. 2-4, second telescopic siderail 108 includes a second outer member 109 and a second inner member 112. The components of the telescopic siderails are discussed further in the sections below.

In the present example, the telescopic siderails are composed of steel. However, the telescopic siderails may be composed of any currently known or later developed material suitable for structural applications. Suitable materials include metals, polymers, ceramics, wood, and composite materials.

### Outer Members

The role of the outer members are to couple telescopic liftgate 100 to cargo bed 140 of vehicle 100. Further, the outer members support the inner members and selectively receive the inner members when the liftgate is in the stowed configuration shown in FIG. 1.

The reader can see in FIGS. 2-4 that first outer member 103 extends from a first end to a second end proximate a rear 106 of vehicle 101. As depicted in FIGS. 2-4, second outer member 109 extends from a third end to a fourth end proximate rear 106 of vehicle 101.

The size and shape of the outer members may be varied as needed for a given application. In some examples, the outer members are larger relative to the other components than depicted in the figures. In other examples, the outer members are smaller relative to the other components than depicted in the figures. Further, the outer members and the other components may all be larger or smaller than described herein while maintaining their relative proportions.

### Inner Members

The role of the inner members is to support the pulleys, winch 116, and platform 115 in cooperation with the elongate tension bearing members. The inner members also serve to move liftgate 100 between the stowed configuration shown in FIG. 1 and the deployed configuration shown in FIG. 2.

As shown in FIGS. 2-4, first inner member 107 is moveably supported by first outer member 103. First inner member 107 is configured to extend beyond the second end of first outer member 103. With reference to FIGS. 24, second inner member 112 is moveably supported by second outer member 109. Second inner member 112 is configured to extend beyond the fourth end of second outer member 109.

The size and shape of the inner members may be varied as needed for a given application. In some examples, the inner members are larger relative to the other components than depicted in the figures. In other examples, the inner members are smaller relative to the other components than depicted in the figures. Further, the inner members and the other components may all be larger or smaller than described herein while maintaining their relative proportions.

### Pulleys

The pulleys serve to support the elongate tension bearing members. Further, the pulleys enable the elongate tension bearing members to extend and retract to lower and raise platform 115, respectfully.

The reader can see in FIGS. 1-4, 6, 7 that first pulley 113 is mounted to first inner member 107. As depicted in FIGS. 1-5, second pulley 123 is mounted to first inner member 107. Second pulley 123 is spaced from first pulley 113.

As shown in FIGS. 2-5, third pulley 129 is mounted to second inner member 112. With reference to FIGS. 2-5, fourth pulley 130 is mounted to second inner member 112. Fourth pulley 130 is spaced from third pulley 129.

The reader can see in FIGS. 1-6 that first pulley 113, second pulley 123, third pulley 129, and fourth pulley 130 are configured to move in tandem. The pulleys moving in tandem allows them to maintain platform 115 in a horizontal orientation when cooperating to raise and lower platform 115.

The pulleys may be any currently known or later developed type of pulley. Various pulley types exist and could be used in place of the pulleys shown in the figures. In addition to the types of pulleys existing currently, it is contemplated that the liftgates described herein could incorporate new types of pulleys developed in the future.

The number of pulleys in the liftgate may be selected to meet the needs of a given application. The reader should appreciate that the number of pulleys may be different in other examples than is shown in the figures. For instance, some liftgate examples include additional or fewer pulleys than described in the present example.

The size and shape of the pulleys may be varied as needed for a given application. In some examples, the pulleys are larger relative to the other components than depicted in the figures. In other examples, the pulleys are smaller relative to the other components than depicted in the figures. Further, the pulleys and the other components may all be larger or smaller than described herein while maintaining their relative proportions.

### Elongate Tension Bearing Members

The elongate tension bearing members serve to support platform 115. Further, in cooperation with winch 116 and other components of liftgate 100, the elongate tension bearing members function to selectively raise and lower platform 115.

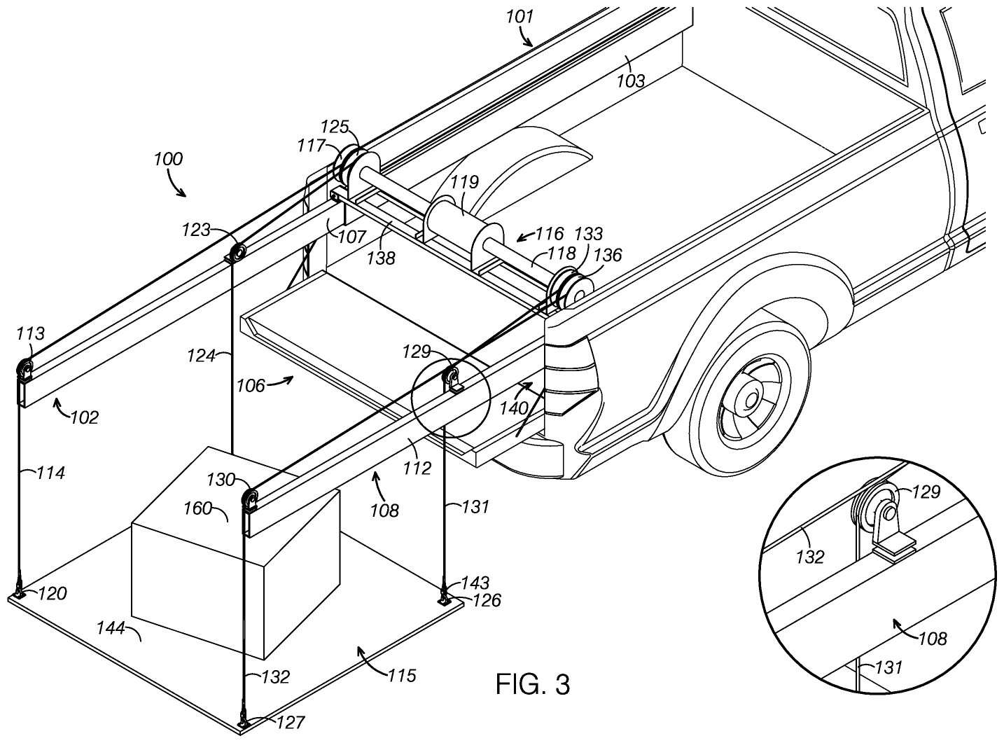

As depicted in FIGS. 3, 6, and 7, first elongate tension bearing member 114 is supported on first pulley 113. As shown in FIGS. 2-5, first elongate tension bearing member 114 is coupled to first mounting point 120. With reference to FIGS. 2-5, second elongate tension bearing member 124 is supported on second pulley 123 and coupled to second mounting point 121. As depicted in FIGS. 2-6, third elongate tension bearing member 131 is supported on third pulley 129 and coupled to third mounting point 126. The reader can see in FIGS. 2-6 that fourth elongate tension bearing member 132 is supported on fourth pulley 130 and coupled to fourth mounting point 127.

With reference to FIGS. 1-7, the elongate tension bearing members are cables. However, the elongate tension bearing members may be any currently known or later developed type of elongate tension bearing member. Various elongate tension bearing member types exist and could be used in place of the elongate tension bearing members shown in the figures. In addition to the types of elongate tension bearing members existing currently, it is contemplated that the liftgates described herein could incorporate new types of elongate tension bearing members developed in the future.

In the present example, liftgate 100 includes four elongate tension bearing members. However, the number of elongate tension bearing members in the liftgate may be selected to meet the needs of a given application. The reader should appreciate that the number of elongate tension bearing members may be different in other examples than is shown in the figures. For instance, some liftgate examples include additional or fewer elongate tension bearing members than described in the present example.

### Platform

Platform 115 functions to support cargo placed thereon, such as cargo item 160 depicted in the figures. The reader can see in FIGS. 2-6 that platform 115, the pulleys, and the elongate tension bearing members cooperate to allow platform 115 to selectively raise and lower. As shown in FIGS. 2-6, platform 115 moves relative to first inner member 107 and second inner member 112.

Liftgate 100 is configured to raise and lower platform 115 when first inner member 107 and second inner member 112 are extended beyond first outer member 103 and second outer member 109, respectfully. In particular, platform raises and lowers when the inner members are extended sufficient that platform 115 is disposed beyond rear 106 of vehicle 101.

As shown in FIG. 3, platform 115 is supported by elongate tension bearing members 114, 124, 131, and 132. As depicted in FIGS. 2-5, platform 115 includes four mounting points to which the elongate tension bearing members couple: a first mounting point 120, a second mounting point 121, a third mounting point 126, and a fourth mounting point 127. Platform 115 also include a base member 144 to which the mounting points are fastened.

With reference to FIGS. 2-5, first and second mounting points 120 and 121 are disposed on a first side of platform 115. With continued reference to FIGS. 2-5, third and fourth mounting points 126 and 127 are disposed on a second side of platform 115 opposite the first side of platform 115.

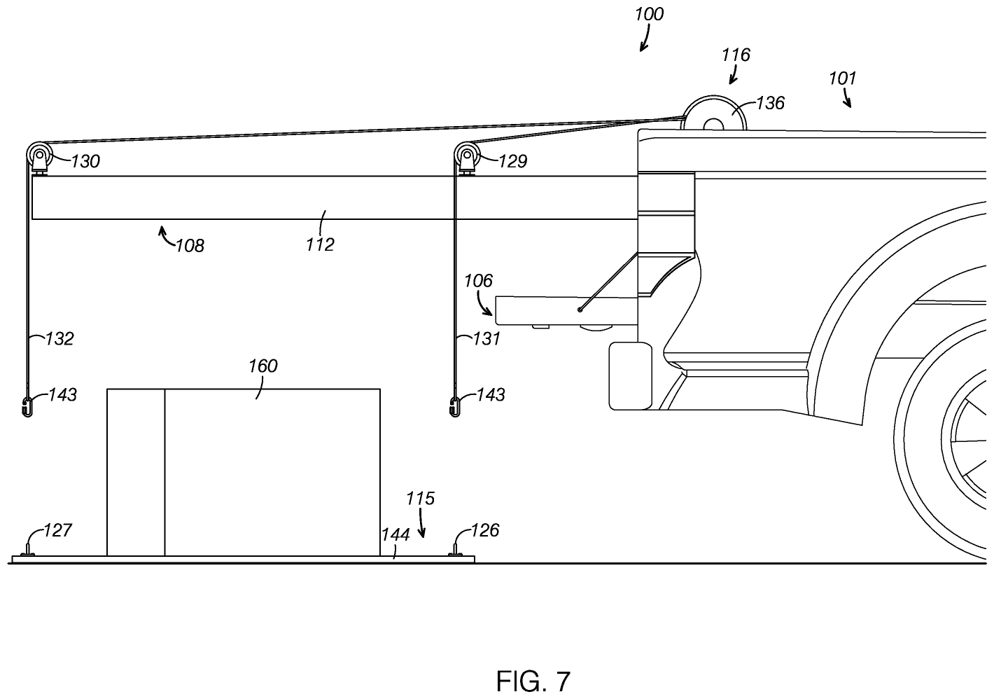

The reader can see in FIG. 7 that platform 115 is removably supported by the elongate tension bearing members. In the example shown in the figures, the elongate tension bearing members selectively couple to the mounting points via a coupler 143 in the form of a threaded carabiner clip. Other types of couplers may be used beyond carabiner clips. In other examples, the elongate tension bearing members fixedly couple to the mounting points.

As shown in FIGS. 1-4, platform 115 is rectangular in the present example. However, the size and shape of the platform may be varied as needed for a given application. In some examples, the platform is larger relative to the other components than depicted in the figures. In other examples, the platform is smaller relative to the other components than depicted in the figures. Further, the platform and the other components may all be larger or smaller than described herein while maintaining their relative proportions.

The platform may be any currently known or later developed type of platform. Various platform types exist and could be used in place of the platform shown in the figures. In addition to the types of platforms existing currently, it is contemplated that the liftgates described herein could incorporate new types of platforms developed in the future.

In the present example, the platform is composed of metal. However, the platform may be composed of any currently known or later developed material suitable for platform applications. Suitable materials include metals, polymers, ceramics, wood, and composite materials.

### Mounting Points

The mounting points serve to selectively couple the elongate tension bearing members to platform 115. As depicted in FIGS. 3-5, first mounting point 120, second mounting point 121, third mounting point 126, and fourth mounting point 127 are located at corners of base member 144 of platform 115.

In the present example, the mounting points are u-shaped rings bolted to base member 144 of platform 115. However, the mounting points may be any currently known or later developed type of mounting point. Various mounting point types exist and could be used in place of the mounting points shown in the figures. In addition to the types of mounting points existing currently, it is contemplated that the liftgates described herein could incorporate new types of mounting points developed in the future.

In the present example, platform 115 includes four mounting points. However, the number of mounting points in the liftgate may be selected to meet the needs of a given application. The reader should appreciate that the number of mounting points may be different in other examples than is shown in the figures. For instance, some liftgate examples include additional or fewer mounting points than described in the present example.

### Winch

The role of winch 116 is to selectively raise and lower platform 115. As shown in FIGS. 1-5, winch 116 is configured to selectively raise and lower platform 115 by spooling and unspooling, respectively, the elongate tension bearing members coupled to platform 115.

With reference to FIGS. 1-5, winch 116 is coupled to the first, second, third, and fourth elongate tension bearing members 114, 124, 131, and 132, respectively. As shown in FIGS. 1-5, winch 116 includes a first spool 117, a second spool 125, a third spool 133, a fourth spool 136, an axle 118, and a motor 119. The components of winch 116 are discussed in the sections below.

The size and shape of the winch may be varied as needed for a given application. In some examples, the winch is larger relative to the other components than depicted in the figures. In other examples, the winch is smaller relative to the other components than depicted in the figures. Further, the winch and the other components may all be larger or smaller than described herein while maintaining their relative proportions.

The winch may be any currently known or later developed type of winch. Various winch types exist and could be used in place of the winch shown in the figures. In addition to the types of winches existing currently, it is contemplated that the liftgates described herein could incorporate new types of winches developed in the future.

In the present example, liftgate 100 includes a single winch. However, the number of winches in the liftgate may be selected to meet the needs of a given application. For example, FIGS. 8 and 9 show a liftgate 200 including two winches, first winch 216 and second winch 250. The reader should appreciate that the number of winches may be different in other examples than is shown in the figures. For instance, some liftgate examples include additional or fewer winches than described in the present example.

### Motor

Motor 119 functions to selectively rotate axle 118. With reference to FIGS. 1-5, the reader can see that motor 119 is drivingly coupled to axle 118. Motor 119 is configured to selectively rotate axle 118 clockwise and counterclockwise.

The size and shape of the motor may be varied as needed for a given application. In some examples, the motor is larger relative to the other components than depicted in the figures. In other examples, the motor is smaller relative to the other components than depicted in the figures. Further, the motor and the other components may all be larger or smaller than described herein while maintaining their relative proportions.

The number of motors in the liftgate may be selected to meet the needs of a given application. The reader should appreciate that the number of motors may be different in other examples than is shown in the figures. For instance, some liftgate examples include additional or fewer motors than described in the present example.

The motor may be any currently known or later developed type of motor. Various motor types exist and could be used in place of the motor shown in the figures. In addition to the types of motors existing currently, it is contemplated that the liftgates described herein could incorporate new types of motors developed in the future.

### Axle

Axle 118 functions to support the spools. The reader can see in FIGS. 1-5 that axle 118 is drivingly coupled to the spools such that the spools rotate in turn with axle 118 when axle 118 is rotated by motor 119.

As depicted in FIGS. 1-5, axle 118 includes a first longitudinal end and a second longitudinal end. The second longitudinal end is disposed opposite the first longitudinal end. As shown in FIGS. 1-5, first spool 117 and second spool 125 are supported on axle 118 proximate the first longitudinal end. Third spool 133 and fourth spool 136 are supported on axle 118 proximate the second longitudinal end.

The size and shape of the axle may be varied as needed for a given application. In some examples, the axle is larger relative to the other components than depicted in the figures. In other examples, the axle is smaller relative to the other components than depicted in the figures. Further, the axle and the other components may all be larger or smaller than described herein while maintaining their relative proportions.

### Spools

The role of the spools is to couple to and selectively wind and unwind the elongate tension bearing members. As shown in FIGS. 1-5, first spool 117 is coupled to and supports first elongate tension bearing member 114. With continued reference to FIGS. 1-5, the reader can see that second spool 125 is coupled to and supports second elongate tension bearing member 124, third spool 133 is coupled to and supports third elongate tension bearing member 131, and fourth spool 136 is coupled to and supports fourth elongate tension bearing member 132.

As shown in FIGS. 1-5, first spool 117 and second spool 125 are supported on axle 118 proximate the first longitudinal end. Third spool 133 and fourth spool 136 are supported on axle 118 proximate the second longitudinal end. Accordingly, first spool 117 and second spool 125 are mounted to axle 118 proximate to each other and third spool 133 and fourth spool 136 are supported on axle 118 proximate to each other.

The size and shape of the spools may be varied as needed for a given application. In some examples, the spools are larger relative to the other components than depicted in the figures. In other examples, the spools are smaller relative to the other components than depicted in the figures. Further, the spools and the other components may all be larger or smaller than described herein while maintaining their relative proportions.

The spools may be any currently known or later developed type of spool. Various spool types exist and could be used in place of the spools shown in the figures. In addition to the types of spools existing currently, it is contemplated that the liftgates described herein could incorporate new types of spools developed in the future.

The number of spools in the liftgate may be selected to meet the needs of a given application. The reader should appreciate that the number of spools may be different in other examples than is shown in the figures. For instance, some liftgate examples include additional or fewer spools than described in the present example.

### Strut

Strut 138 functions to brace first telescopic siderail 102 and second telescopic siderail 108. As shown in FIGS. 1-3 and 5, strut 138 extends between first telescopic siderail 102 and second telescopic siderail 108. The reader can see in FIGS. 1-3 and 5 that strut 138 extends from the first end of first telescopic siderail 102 to the third end of second telescopic siderail 108.

In some examples, the strut defines a first strut and the telescopic liftgate includes a second strut. The second strut may be spaced from the first strut. The second strut may extend between the first telescopic siderail and the second telescopic siderail. In certain examples, the second strut extends from the second end of the first telescopic siderail to the fourth end of the second telescopic siderail.

The struts may be any currently known or later developed type of strut. Various strut types exist and could be used in place of the struts shown in the figures. In addition to the types of struts existing currently, it is contemplated that the liftgates described herein could incorporate new types of struts developed in the future.

The number of struts in the liftgate may be selected to meet the needs of a given application. The reader should appreciate that the number of struts may be different in other examples than is shown in the figures. For instance, some liftgate examples include additional or fewer struts than described in the present example.

The size and shape of the struts may be varied as needed for a given application. In some examples, the struts are larger relative to the other components than depicted in the figures. In other examples, the struts are smaller relative to the other components than depicted in the figures. Further, the struts and the other components may all be larger or smaller than described herein while maintaining their relative proportions.

In the present example, the struts are composed of steel. However, the struts may be composed of any currently known or later developed material suitable for bracing applications. Suitable materials include metals, polymers, ceramics, wood, and composite materials.

### Additional Embodiments

With reference to the figures not yet discussed in detail, the discussion will now focus on additional liftgate embodiments. The additional embodiments include many similar or identical features to liftgate 100. Thus, for the sake of brevity, each feature of the additional embodiments below will not be redundantly explained. Rather, key distinctions between the additional embodiments and liftgate 100 will be described in detail and the reader should reference the discussion above for features substantially similar between the different liftgate examples.

### Liftgate Embodiment Two

Turning attention to FIGS. 8 and 9, a liftgate 200 will now be described as a second example of a liftgate. As can be seen in FIGS. 8 and 9, liftgate 200 includes a first telescopic siderail 202, a second telescopic siderail 208, a first pulley 213, a second pulley 223, a third pulley 229, a fourth pulley 230, a first elongate tension bearing member 214, a second elongate tension bearing member 224, a third elongate tension bearing member 231, a fourth elongate tension bearing member 232, a platform 215, a first winch 216, a second winch 250, and a strut 238. In other examples, the liftgate includes fewer components than depicted in the figures. In certain examples, the liftgate includes additional or alternative components than depicted in the figures.

One difference between liftgate 100 and liftgate 200 is that liftgate 200 is mounted to cargo rack 241 whereas liftgate 100 is mounted to cargo bed 140 of vehicle 101. The reader can see in FIGS. 8 and 9 that cargo rack 241 is mounted to a cargo bed 240 of vehicle 201. By mounting to cargo rack 241, liftgate 200 is elevated relative to liftgate 100.

Another difference between liftgate 100 and liftgate 200 is that liftgate 200 includes two winches whereas liftgate 100 includes a single winch. As shown in FIGS. 8 and 9, liftgate 200 with first winch 216 and second winch 250 is adapted to selectively tilt platform 215. In particular, with continued reference to FIGS. 8 and 9, first winch 216 and second winch 250 are configured to cooperatively operate to selectively tilt platform 215 by selectively extending elongate tension bearing members secured to one side of platform 215 to different extents than they extend elongate tension bearing members secured to an opposite side of platform 215. Selectively tilting platform 215 may facilitate loading cargo onto platform 215 and/or offloading cargo from platform 215.

The reader can see in FIGS. 8 and 9 that first winch 216 includes a first spool 217, a fourth spool 236, a first axle 218, and a first motor 219. Second winch 250 includes a second spool 225, a third spool 233, a second axle 251, and a second motor 252.

Selectively operating first winch 216 selectively raises and lowers a front end of platform 215. Selectively operating second winch 250 selectively raises and lowers a rear end of platform 215. First winch 216 and second winch 216 may be operated in tandem to maintain platform 215 in a horizontal orientation or may be operated disparately to selectively tilt platform 215, such as to make offloading cargo from platform 215 or loading cargo onto platform 215 easier.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A liftgate for a vehicle, comprising:
a first telescopic siderail including:
a first outer member extending from a first end to a second end proximate a rear of the vehicle, and
a first inner member moveably supported by the first outer member and configured to extend beyond the second end of the first outer member;
a second telescopic siderail extending parallel to the first telescopic siderail, the second telescopic siderail including:
a second outer member extending from a third end to a fourth end proximate the rear of the vehicle; and
a second inner member moveably supported by the second outer member and configured to extend beyond the fourth end of the second outer member:
a first pulley mounted to the first inner member;
a first elongate tension bearing member supported on the first pulley; and
a platform supported by the first elongate tension bearing member;
wherein the platform, the first pulley, and the first elongate tension bearing member cooperate to allow the platform to selectively raise and lower relative to the first inner member and the second inner member when the first inner member and the second inner member are extended beyond the first outer member and the second outer member, respectfully, sufficient that the platform is disposed beyond the rear of the vehicle.

2. The liftgate of claim 1, further comprising a winch coupled to the first elongate tension bearing member and configured to selectively raise and lower the platform by spooling and unspooling, respectively, the first elongate tension bearing member.

3. The liftgate of claim 2, wherein the winch includes:
a first spool coupled to and supporting the first elongate tension bearing member,
an axle drivingly coupled to the spool; and
a motor drivingly coupled to the axle and configured to selectively rotate the axle clockwise and counterclockwise.

4. The liftgate of claim 3, wherein:
the platform includes a first mounting point and a second mounting point on a first side of the platform;
the first elongate tension bearing member is coupled to the first mounting point; and
the liftgate further comprises:
a second pulley mounted to the first inner member and spaced from the first pulley; and
a second elongate tension bearing member supported on the second pulley and coupled to the second mounting point.

5. The liftgate of claim 4, further comprising a second spool mounted to the axle and coupled to the second elongate tension bearing member.

6. The liftgate of claim 4, wherein:
the platform includes a third mounting point and a fourth mounting point on a second side of the platform opposite the first side of the platform; and
the liftgate further comprises:
a third pulley mounted to the second inner member,
a fourth pulley mounted to the second inner member and spaced from the third pulley;
a third elongate tension bearing member supported on the third pulley and coupled to the third mounting point; and
a fourth elongate tension bearing member supported on the fourth pulley and coupled to the fourth mounting point.

7. The liftgate of claim 6, further comprising a third spool mounted to the axle and coupled to the third elongate tension bearing member.

8. The liftgate of claim 7, wherein:
the axle includes a first longitudinal end and a second longitudinal end opposite the first longitudinal end;
the first spool is mounted to the axle proximate to the first longitudinal end;
the third spool is mounted to the axle proximate to the second longitudinal end.

9. The liftgate of claim 8, wherein the second spool is mounted to the axle proximate to the first spool.

10. The liftgate of claim 9, further comprising a fourth spool coupled to the axle and coupled to the fourth elongate tension bearing member.

11. The liftgate of claim 10, wherein the fourth spool is mounted to the axle proximate to the third spool.

12. The liftgate of claim 6, wherein the first pulley, the second pulley, the third pulley, and the fourth pulley are configured to move in tandem to maintain the platform in a horizontal orientation when cooperating to raise and lower the platform.

13. The liftgate of claim 6, wherein the platform is rectangular.

14. The liftgate of claim 13, wherein the first mounting point, the second mounting point, the third mounting point, and the fourth mounting point are located at corners of the platform.

15. The liftgate of claim 4, wherein:
the winch defines a first winch;
the liftgate further comprises a second winch;
the second winch includes:
a second spool coupled to and supporting the second elongate tension bearing member,
a second axle drivingly coupled to the second spool; and
a second motor drivingly coupled to the second axle and configured to selectively rotate the second axle clockwise and counterclockwise; and
the first winch and the second are configured to cooperatively operate to selectively tilt the platform.

16. The liftgate of claim 1, further comprising a strut extending between the first telescopic siderail and the second telescopic siderail.

17. The liftgate of claim 16, wherein the strut extends from the first end of the first telescopic siderail to the third end of the second telescopic siderail.

18. The liftgate of claim 1, wherein the liftgate mounts to a cargo rack mounted to the vehicle.

19. The liftgate of claim 1, wherein the first elongate tension bearing member is a cable.

20. The liftgate of claim 1, wherein the platform is removably supported by the first elongate tension bearing member.
